(19) United States
(12) Patent Application Publication
(10) Pub. No.: US 2004/0041698 A1
(43) Pub. Date: Mar. 4, 2004

(54) Code learning device for tire pressure monitor

(75) Inventor: Sheng Hsiung Lin, Kaohsiung (TW)

Correspondence Address: LOWE HAUPTMAN GILMAN & BERNER, LLP, Suite 310, 1700 Diagonal Road, Alexandria, VA, 22314, US

(73) Assignee: LITE-ON AUTOMOTIVE CORP.

(21) Appl. No.: 10/388,461

(22) Filed: Mar. 17, 2003

(30) Foreign Application Priority Data
Aug. 30, 2002 (TW) 091119986

(51) Int. Cl. B60C 23/00

(52) U.S. Cl. 340/447

(57) ABSTRACT

A code learning device for a tire pressure monitor attached to a vehicle comprises a sensor module installed in a tire of the vehicle for sensing the condition of the tire and transmitting the condition by a radio frequency (RF) signal. The sensor module further comprises a transponder for generating the electric power in response to an electromagnetic wave, thereby transmitting the identifying code of the sensor module.

### CROSS REFERENCE TO RELATED APPLICATION

This application claims the priority benefit of Taiwan application serial no. 091119986, filed Aug. 30, 2002, the full disclosure of which is incorporated herein by reference.

### BACKGROUND OF THE INVENTION

1. Field of the Invention

The present invention generally relates to a code learning device for a tire pressure monitor, and more particularly relates to a code learning device for a tire pressure monitor monitoring the conditions of tires, which is provided with a simplified code learning process.

2. Description of the Related Art

Many related technologies and devices for monitoring the pressure of the tires have been known in the conventional arts. For example, U.S. patent application Ser. No. 09/910,725 entitled “Method for Monitoring Tire Pressure of Pneumatic Tire and Device Therefor” filed on Jul. 24, 2001 and commonly assigned to the assignee of the present application, discloses a device which comprises sensor modules installed in each of the pneumatic tires for sensing the conditions of the tires, and then encoding and transmitting the conditions of the tires by radio frequency signals. The device also has a decoder module for receiving the radio frequency signals transmitted by the sensor module and thus determining the present conditions of the pneumatic tires.

However, in the above mentioned patent application, while the decoder module identifies the relationship between the code of the sensor module and the positions of the pneumatic tires, the operator has to deflate the tires of the vehicle. By rapid changing of the tire pressure, the sensor modules installed in the tires continuously transmit signals and then the decoder recognizes the code in the signals, thereby identifying the relationship between the positions of the tires and the sensor modules installed therein. Then, the deflated tires of the vehicle have to be inflated before the driver use the vehicle again. Obviously, such process is relatively time consuming, inconvenient, and complicated.

Besides, U.S. Pat. No. 6,369,703 issued to Lill on Apr. 9, 2002 entitled “Tire pressure monitor and location identification system”, discloses a tire pressure monitoring and identification system in a vehicle includes a tire pressure monitor operatively connected to each tire, a plurality of transponders, and a central system receiver. Each of the transponders has a unique identification code and is fixed to the vehicle adjacent to a predetermined tire. During operation, each tire pressure monitor transmits tire pressure data to its corresponding transponder. The transponder adds its unique location identification code to the tire pressure data and transmits the data to the central system receiver. The central system receiver selectively displays the tire pressure data by tire location. However, the tire pressure monitoring of this patent is complex and easily influenced by the environmental electromagnetic waves.

Therefore, the foregoing conventional code learning methods are unable to provide a fast and effective code learning mode. There exists a need for a code learning device and method of tire pressure monitor to simplifying the code learning process of the tire pressure monitor.

### SUMMARY OF THE INVENTION

It is an object of the present invention to provide a tire monitoring device for monitoring conditions of tires, and the tire monitoring device is able to easily identify the positions of the tire pressure sensors installed in the respective tires.

It is another object of the present invention to provide a code learning method of tire monitoring device for identifying the positions of the tire pressure sensor installed in the respective tires without complex operations.

In order to achieve the objects mentioned hereinabove, the present invention provides a code learning device for a tire pressure monitor attached to a vehicle. The code learning device comprises a sensor module installed in a tire of the vehicle for sensing the condition of the tire and transmitting the condition by a radio frequency (RF) signal. The sensor module further comprises a transponder for generating the electric power in response to an electromagnetic wave, thereby transmitting the identifying code of the sensor module. The code learning device further comprises a reader for transmitting the electromagnetic wave of the first frequency and receiving the identifying code transmitted from the transponder, and a tire monitoring module installed in the vehicle for receiving the condition transmitted from the sensor module.

According to another aspect of the present invention, the present invention further provides a code learning method for a tire monitoring device attached to a vehicle comprising the following steps of: providing a plurality of sensor modules installed in the respective tires of the vehicle for sensing the conditions of the tires and transmitting the signals including the conditions, and having an identifying code; providing a plurality of transponders respectively attached to the sensor modules for be induced by an electromagnetic wave at a first frequency so as to transmit the identifying code of the sensor module; and transmitting the electromagnetic wave of the first frequency in the vicinity of one of the tires for inducing the transponder installed in the one of the tires and transmitting the identifying code of the sensor module installed in the one of the tires.

Accordingly, since the tire monitor according to the present invention is provided with the transponder, the user easily identifies the identifying code of the sensor module installed in the tires. Further, the power supply is not required for the transponder, so the lifetime of the sensor module is not reduced due to the operating of the transponder.

### BRIEF DESCRIPTION OF THE DRAWINGS

Other objects, advantages, and novel features of the invention will become more apparent from the following detailed description when taken in conjunction with the accompanying drawings.

FIG. 1 is a system block diagram of a tire monitoring device comprising a code learning device according to the present invention.

FIG. 2 is a schematic circuit diagram of the transponder shown in FIG. 1 which includes an integrated circuit (IC) and a parallel inductor-capacitor oscillation circuit.

### DESCRIPTION OF THE PREFERRED EMBODIMENT

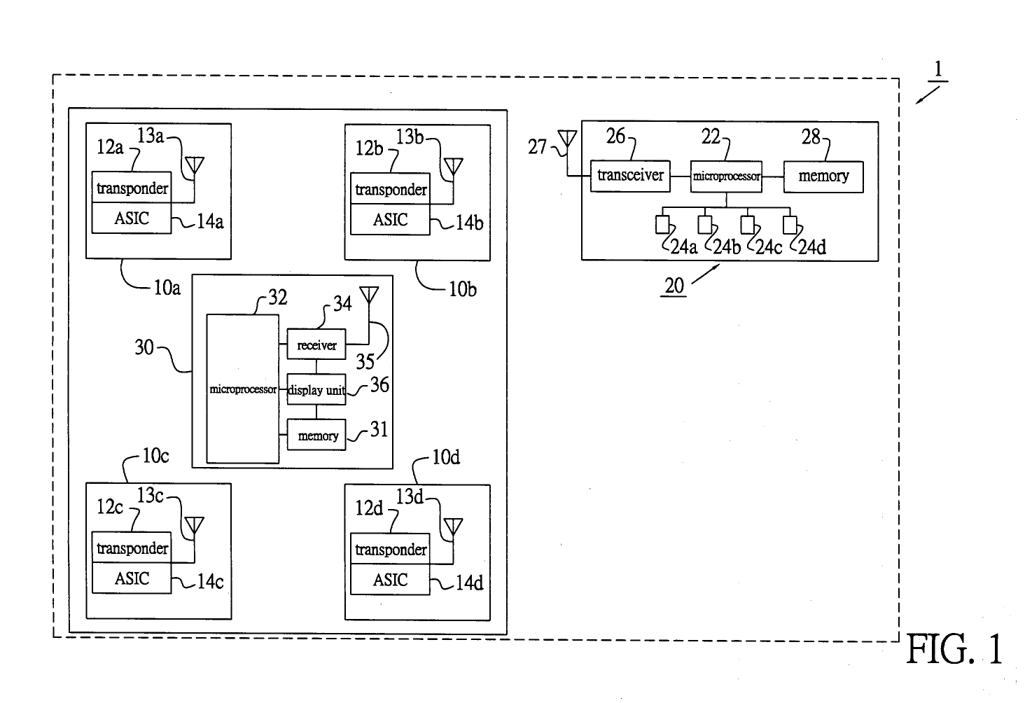

Now referring to FIG. 1, it shows a block diagram of a tire monitoring device 1 with code learning function according to the present invention. The tire monitoring device 1 installed in a vehicle comprises a plurality of sensor modules 10a, 10b, 10c, 10d, and a tire monitoring module 30. The tire monitoring module 30 includes a microprocessor 32, a receiver 34 with an antenna 35, and a display unit 36.

The sensor modules 10a, 10b, 10c, and 10d are respectively installed in the front right (FR) tire, the front left (FL) tire, the rear right (RR) tire, and the rear left (RL) tire of a vehicle. The sensor modules 30a-d comprise sensor application-specific integrated circuits (ASIC) 14a, 14b, 14c, 14d for sensing the condition of the tires in the vehicle and an antennas 13a, 13b, 13c, 13d for transmitting the condition. Specifically, the ASICs 14a-d are used for sensing the conditions of the tires, such as pressure and temperature of the tires, and then encoding and transmitting the conditions of the tires by radio frequency signals via the antennas 13a-d. Each of the ASICs 14a-d further comprise an identifying code which is transmitted with the radio frequency signals. Such sensor module can be seen in the U.S. patent application Ser. No. 09/910,725 entitled “Method for Monitoring Tire Pressure of Pneumatic Tire and Device Therefor” filed on Jul. 24, 2001, which is commonly assigned to the assignee of the present application and incorporated herein by reference.

The tire monitoring device 1 according to the present invention further a hand held reader 20, and the sensor modules 10a, 10b, 10c, 10d respectively comprise transponders 12a, 12b, 12c, 12d. The hand held reader 20 includes a microprocessor 22, transmitting buttons 24a, 24b, 24c, 24d, a transceiver 26 with an antenna 27, and a memory 28. It will be apparent to those skilled in the art that the transponders 12a-d can be induced by a radio wave or an electromagnetic wave at a specific frequency for generating power and powering an integrated circuit (IC), thereby transmitting the identifying code of the ASICs 14a-d. Also, since the hand held reader 20 is provided with the transmitting buttons 24a-d, the hand held reader 20 can transmit the radio wave at the specific frequency when the transmitting buttons 24a-d is pressed.

Before the tire monitoring device 1 according the present invention is used for monitoring the condition of the tires, the tire monitoring device 1 firstly needs to carry out a code learning process for identifying the identifying codes of the sensor modules installed in the respective tires of the vehicle. In the code learning process, for example, the user holds the hand held reader 20, approaches the front right (FR), and presses the transmitting button 24a for transmitting the radio wave at the specific frequency. The transponder 12a is induced by the radio wave of the specific frequency for generating electric power and powering the IC which transmits the identifying code of the ASIC 14a via another radio frequency signal. The transceiver 26 of the hand held reader 20 may receive the radio frequency signal and store the identifying code of the ASIC 14a installed in the front right tire into the memory 28. The user then approaches the other tires and presses the respective transmitting button 24b, 24c, 24d so that all of the identifying codes of the ASICs installed in the tires is identified. Then, the hand held reader 20 transmits the identifying codes of the respective tires to the memory 31 in the tire monitoring module 30 by means of radio waves or a transmitting line, whereby the tire monitoring module 30 receives the signals of the tire conditions from the sensor modules 10a-d installed in the respective tires and identifies the tire from which the signals is transmitted. Further, the tire monitoring module 30 can transmit the conditions of the tires to the hand held reader 20 by radio waves or a transmitting line for providing the function of remote monitoring.

Furthermore, according to the embodiment of the present invention, while the user manipulates the hand held reader 20 for actuating the transponder, the intensity or amplitude of the radio wave at the specific frequency transmitted from the hand held reader 20 is limited such that the intensity of the radio wave is not enough to actuate the transponder until the hand held reader 20 approaches the transponder (i.e. the tire) below the distance which is from about 7 to about 20 cm, thereby avoiding the influence of the other tires.

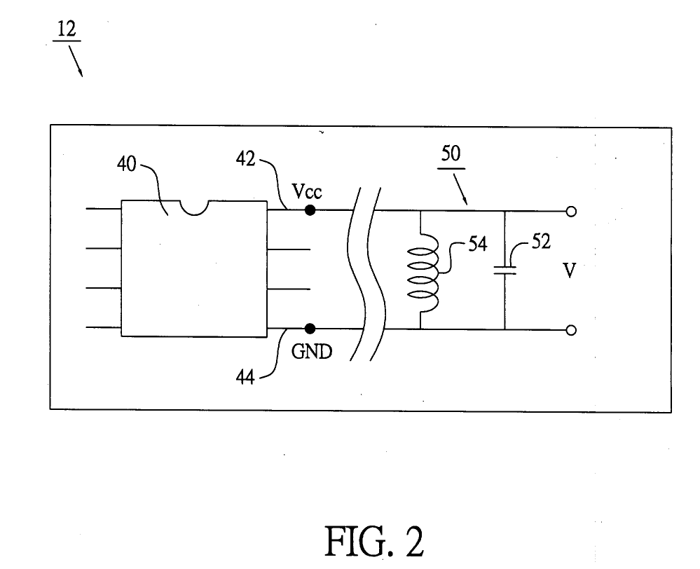

More specifically, as shown in FIG. 2, the transponder 12 is provided with an integrated circuit (IC) 40 and a parallel inductor-capacitor oscillation circuit 50 which is electrically connected to the VCC (Power) pin 42 and the GND (Ground) pin 44 of the IC 40. The oscillation frequency of the oscillation circuit 50 is the specific frequency. Accordingly, when the hand held reader 20 approaches the oscillation circuit 50 and transmits the radio wave at the specific frequency, the oscillation circuit 50 is induced by the radio wave for generating the voltage and powering the integrated circuit 40 to transmit another radio frequency signal which comprises the identifying code of the ASIC and is received by the hand held reader 20.

In a specific case, the specific frequency of the transponders 12a-d is about 125 KHz and the frequency of the radio frequency signal transmitted from the transponders 12a-d is about 422.92 MHz or about 315 MHz.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A code learning device for a tire monitoring device attached to a vehicle, comprising:
at least one sensor module installed in a tire of the vehicle for sensing the condition of the tire and transmitting the condition by a radio frequency (RF) signal, and having an identifying code; and
at least one transponder for being induced by an electromagnetic wave at a first frequency so as to transmit the identifying code of the sensor module.

2. The code learning device according to claim 1, further comprising:
a reader for transmitting the electromagnetic wave of the first frequency and receiving the identifying code transmitted from the transponder.

3. The code learning device according to claim 2, further comprising:
a tire monitoring module installed in the vehicle for receiving the condition transmitted from the sensor module.

4. The code learning device according to claim 1, wherein the transponder comprises a parallel inductor-capacitor oscillation circuit.

5. The code learning device according to claim 3, wherein the tire monitoring module receives the identifying code of the sensor module from the reader via a radio wave.

6. The code learning device according to claim 3, wherein the tire monitoring module receives the identifying code of the sensor module from the reader via a transmitting line.

7. The code learning device according to claim 3, wherein the tire monitoring module further comprises a memory for storing the identifying code.

8. The code learning device according to claim 1, wherein the first frequency is about 125 KHz.

9. The code learning device according to claim 1, wherein the sensor module transmits the condition of the tire via an electromagnetic wave at a second frequency, and the transponder transmits the identifying code of the sensor module via the electromagnetic wave of the first frequency.

10. The code learning device according to claim 9, wherein the second frequency is about 433.92 MHz.

11. The code learning device according to claim 9, wherein the second frequency is about 315 MHz.

12. The code learning device according to claim 9, wherein the condition of the tire is selected from the group consisting of pressure, temperature, and the combination thereof.

13. A code learning method for a tire monitoring device attached to a vehicle, comprising the following steps of:
providing a plurality of sensor modules installed in the respective tires of the vehicle for sensing the conditions of the tires and transmitting the signals including the conditions, and having an identifying code;
providing a plurality of transponders respectively attached to the sensor modules for being induced by an electromagnetic wave at a first frequency so as to transmit the identifying code of the sensor module; and
transmitting the electromagnetic wave of the first frequency in the vicinity of one of the tires for inducing the transponder installed in the one of the tires and transmitting the identifying code of the sensor module installed in the one of the tires.

14. The code learning method according to claim 13, further comprising the steps of:
recording the relationship between the identifying codes of the sensor modules and the positions of the tires;
providing a tire monitoring module installing in the vehicle for receiving the conditions of the tires transmitted from the sensor modules in the tires; and
transmitting the relationship between the identifying codes of the sensor modules and the positions of the tires to the tire monitoring module.

15. The code learning method according to claim 13, wherein the electromagnetic wave of the first frequency is transmitted at the distance of about 7 cm to about 20 cm to the one of the tires.

16. The code learning method according to claim 13, wherein the transponder comprises a parallel inductor-capacitor oscillation circuit for being induced by the electromagnetic wave of the first frequency.

17. The code learning method according to claim 13, wherein the first frequency is about 125 KHz.

18. The code learning method according to claim 13, wherein the sensor module transmits the condition of the tire via an electromagnetic wave at a second frequency, and the transponder transmits the identifying code of the sensor module via the electromagnetic wave of the first frequency.

19. The code learning method according to claim 18, wherein the second frequency is about 433.92 MHz.

20. The code learning method according to claim 18, wherein the second frequency is about 315 MHz.

21. The code learning method according to claim 13, wherein the condition of the tire is selected from the group consisting of pressure, temperature, and the combination thereof.
